(19) United States
(12) Patent Application Publication
(10) Pub. No.: US 2025/0041794 A1
(43) Pub. Date: Feb. 6, 2025

(54) HUMIDITY-CONTROLLING MATERIAL

(71) Applicant: SHARP KABUSHIKI KAISHA, Sakai City, Osaka (JP)

(72) Inventors: Yuusuke SHIMIZU, Sakai City, Osaka (JP); TSUYOSHI KAMADA, Sakai City, Osaka (JP); MASAKAZU KAMURA, Sakai City, Osaka (JP); TETSUYA IDE, Sakai City, Osaka (JP); SHO OCHI, Sakai City, Osaka (JP); KYOKO MATSUURA, Sakai City, Osaka (JP); HIROKA HAMADA, Sakai City, Osaka (JP); SATORU MOTONAMI, Sakai City, Osaka (JP)

(21) Appl. No.: 18/714,990

(22) PCT Filed: Nov. 29, 2022
(86) PCT No.: PCT/JP2022/043834

§ 371 Date: May 30, 2024

(30) Foreign Application Priority Data
Nov. 30, 2021 (JP) 2021-193812

(51) Int. Cl. B01D 53/28; B01J 20/12; B01J 20/26; B01J 20/28

(52) U.S. Cl. CPC B01D 53/28; B01J 20/12; B01J 20/261; B01J 20/28016; B01J 20/28033

(57) ABSTRACT

A humidity-controlling material includes: a water-absorbing body containing a water-absorbing material; and a humidity-controlling component configured to be present in the water-absorbing material and to absorb or release moisture, wherein the humidity-controlling component includes: a first salt containing first anions and first cations and having a deliquescence point in a relative humidity range of from 30% RH to 80% RH both inclusive; and a second salt containing second anions that differ from the first anions and second cations that differ from the first cations.

### TECHNICAL FIELD

The present disclosure relates to humidity-controlling materials. The present application claims the benefit of priority to Japanese Patent Application No. 2021-193812 filed on Nov. 30, 2021, the entire contents of which are incorporated herein by reference.

### BACKGROUND ART

Humidity-controlling materials have a high humidity-controlling capability in comparison with general desiccants composed of B-type silica gel. Therefore, humidity-controlling materials are widely applicable.

Patent Literature 1 discloses a hygroscopic composition that contains either or both of sodium acetate and potassium acetate and a water-absorbing binder and in which the ratio of the total amount of sodium acetate and potassium acetate (Ac) and the amount of water-absorbing binder (B) (Ac:B [mass ratio]) is in the range of from 2:3 to 4:1. This configuration provides an inexpensive and highly safe hygroscopic composition with high hygroscopicity for which sodium acetate and/or potassium acetate, which are a non-halogenated inorganic salt, are used and that is unlikely to cause, for example, metal rust.

### CITATION LIST

### Patent Literature

Patent Literature 1: Japanese Unexamined Patent Application Publication No. 2012-245489.

### SUMMARY

### Technical Problem

The humidity-controlling material is required to have a high humidity-controlling capability at both low humidity and high humidity. However, some humidity-controlling materials that have a high humidity-controlling capability at high humidity have only a low humidity-controlling capability at low humidity, which is undesirable in some situations.

The present disclosure has been made in view of this problem. The present disclosure, in an aspect thereof, has an object to provide, for example, a humidity-controlling material that has a high humidity-controlling capability at both low humidity and high humidity.

### Solution to Problem

The present disclosure, in an aspect thereof, is directed to a humidity-controlling material including: a water-absorbing body containing a water-absorbing material; and a humidity-controlling component configured to be present in the water-absorbing material and to absorb or release moisture, wherein the humidity-controlling component includes: a first salt containing first anions and first cations and having a deliquescence point in a relative humidity range of from 30% RH to 80% RH both inclusive; and a second salt containing second anions that differ from the first anions and second cations that differ from the first cations.

### BRIEF DESCRIPTION OF DRAWINGS

FIG. 1 is a schematic cross-sectional view of a humidity-controlling material in accordance with Embodiment 1.

FIG. 2 is a graph representing moisture sorption isotherms of sodium acetate, sodium propionate, and sodium formate.

FIG. 3 is a schematic diagram of a fine structure of a humidity-controlling component contained in a humidity-controlling material in accordance with a comparative example at high humidity.

FIG. 4 is a schematic diagram of the fine structure of the humidity-controlling component contained in the humidity-controlling material in accordance with the comparative example at low humidity.

FIG. 5 is a schematic diagram of a fine structure of a humidity-controlling component contained in a humidity-controlling material in accordance with an example at high humidity.

FIG. 6 is a schematic diagram of the fine structure of the humidity-controlling component contained in the humidity-controlling material in accordance with the example at low humidity.

FIG. 7 is a graph representing moisture sorption isotherms of the humidity-controlling component contained in a humidity-controlling material in accordance with a comparative example and the humidity-controlling component contained in a humidity-controlling material in accordance with an example.

FIG. 8A is a schematic diagram illustrating a method of manufacturing a humidity-controlling material in accordance with Embodiment 1.

FIG. 8B is a schematic diagram illustrating the method of manufacturing the humidity-controlling material in accordance with Embodiment 1.

FIG. 8C is a schematic diagram illustrating the method of manufacturing the humidity-controlling material in accordance with Embodiment 1.

FIG. 9 is a graph representing moisture sorption isotherms of a humidity-controlling material in accordance with Example 1, a humidity-controlling material in accordance with Example 2, and a humidity-controlling material in accordance with Comparative Example 1.

FIG. 10 is a graph representing moisture sorption isotherms of a humidity-controlling material in accordance with Example 3 and a humidity-controlling material in accordance with Comparative Example 1.

FIG. 11 is a graph representing moisture sorption isotherms of a humidity-controlling material in accordance with Example 4 and a humidity-controlling material in accordance with Comparative Example 1.

FIG. 12 is a graph representing moisture sorption isotherms of a humidity-controlling material in accordance with Example 5 and a humidity-controlling material in accordance with Comparative Example 1.

FIG. 13 is a graph representing moisture sorption isotherms of a humidity-controlling material in accordance with Example 6, a humidity-controlling material in accordance with Example 7, and a humidity-controlling material in accordance with Comparative Example 1.

FIG. 14 is a graph representing moisture sorption isotherms of a humidity-controlling material in accordance with Comparative Example 1 and a humidity-controlling material in accordance with Comparative Example 2.

FIG. 15 is a schematic plan view of a first alternative example of water-absorbing bodies contained in the humidity-controlling material in accordance with Embodiment 1.

FIG. 16 is a schematic perspective view of a second alternative example of the water-absorbing body contained in the humidity-controlling material in accordance with Embodiment 1.

FIG. 17 is a schematic cross-sectional view of a third alternative example of the water-absorbing body contained in the humidity-controlling material in accordance with Embodiment 1.

FIG. 18 is a schematic cross-sectional view of a fourth alternative example of the water-absorbing body contained in the humidity-controlling material in accordance with Embodiment 1.

FIG. 19 is a schematic cross-sectional view of a fifth alternative example of the water-absorbing body contained in the humidity-controlling material in accordance with Embodiment 1.

FIG. 20A is a schematic diagram illustrating a first method of manufacturing a humidity-controlling material in accordance with Embodiment 1 when this humidity-controlling material is in sheet form.

FIG. 20B is a schematic diagram illustrating the first method of manufacturing the humidity-controlling material in accordance with Embodiment 1 when this humidity-controlling material is in sheet form.

FIG. 20C is a schematic diagram illustrating the first method of manufacturing the humidity-controlling material in accordance with Embodiment 1 when this humidity-controlling material is in sheet form.

FIG. 21A is a schematic diagram illustrating a second method of manufacturing a humidity-controlling material in accordance with Embodiment 1 when this humidity-controlling material is in sheet form.

FIG. 21B is a schematic diagram illustrating the second method of manufacturing the humidity-controlling material in accordance with Embodiment 1 when this humidity-controlling material is in sheet form.

FIG. 21C is a schematic diagram illustrating the second method of manufacturing the humidity-controlling material in accordance with Embodiment 1 when this humidity-controlling material is in sheet form.

FIG. 21D is a schematic diagram illustrating the second method of manufacturing the humidity-controlling material in accordance with Embodiment 1 when this humidity-controlling material is in sheet form.

FIG. 21E is a schematic diagram illustrating the second method of manufacturing the humidity-controlling material in accordance with Embodiment 1 when this humidity-controlling material is in sheet form.

FIG. 21F is a schematic diagram illustrating the second method of manufacturing the humidity-controlling material in accordance with Embodiment 1 when this humidity-controlling material is in sheet form.

FIG. 22 is a schematic diagram of exemplary changes in the color of a humidity-controlling material in accordance with Embodiment 2.

FIG. 23 is a schematic cross-sectional view of a humidity-controlling material with a packaging member in accordance with Embodiment 3.

FIG. 24 is a schematic cross-sectional view of a humidity-controlling material with a packaging member in accordance with a variation example of Embodiment 3.

### DESCRIPTION OF EMBODIMENTS

The following will describe embodiments of the present disclosure with reference to drawings. Note that identical and equivalent elements in the drawings are denoted by the same reference numerals, and description thereof is not repeated.

### 1 Embodiment 1

### 1.1 Humidity-controlling Material

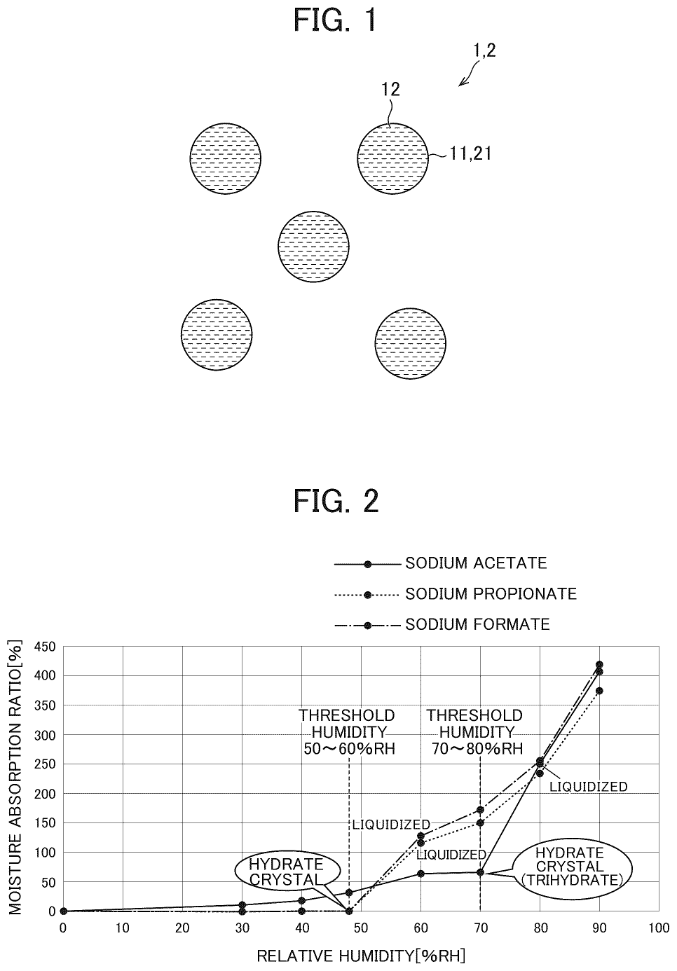

FIG. 1 is a schematic cross-sectional view of a humidity-controlling material in accordance with Embodiment 1.

A humidity-controlling material 1 in accordance with Embodiment 1 shown in FIG. 1 absorbs moisture from air around the humidity-controlling material 1 when the air around the humidity-controlling material 1 has a higher relative humidity than the equilibrium humidity of the humidity-controlling material 1 and releases moisture to the air around the humidity-controlling material 1 when the air around the humidity-controlling material 1 has a lower relative humidity than the equilibrium humidity of the humidity-controlling material 1. The humidity-controlling material 1 is capable of desorbing moisture through heating at lower temperature than the desiccants which is typically an A-type silica gel. The humidity-controlling material 1 is also capable of repeatedly absorbing and releasing moisture. Therefore, the humidity-controlling material 1 can, in principle, semi-permanently retain its humidity-controlling capability to absorb moisture from the air around it and release moisture to the air around it. The equilibrium humidity of the humidity-controlling material 1 is adjustable through the composition of the humidity-controlling material 1.

Referring to FIG. 1, the humidity-controlling material 1 contains water-absorbing bodies 11 and a humidity-controlling component 12. The water-absorbing bodies 11 contain a water-absorbing material 21. The humidity-controlling component 12 is present in the water-absorbing material 21. The humidity-controlling component 12 either absorbs or releases moisture. The humidity-controlling component 12 contains a deliquescent component.

The water-absorbing bodies 11 and the water-absorbing material 21 are in particulate form. The water-absorbing bodies 11 and the water-absorbing material 21 have a diameter of, for example, from a few millimeters to a few tens of millimeters.

The water-absorbing material 21 can chemically or physically absorb the deliquescent component contained in the humidity-controlling component 12. This enables restraining the deliquescenced component from disengaging from the water-absorbing material 21 and water from disengaging from the water-absorbing material 21. When the humidity-controlling component contains, for example, water and/or polyhydric alcohol as well as a first salt and a second salt and is a humidity-controlling liquid as will be described later, the water-absorbing material 21 may be impregnated with a humidity-controlling liquid. The water-absorbing material 21, in every 100 parts by weight thereof, may preferably be impregnated with 1 part by weight to 1,000 parts by weight both inclusive of the humidity-controlling liquid. This use of the humidity-controlling liquid impregnating the water-absorbing material 21 increases the area of the interface between the humidity-controlling component and air in comparison with when the humidity-controlling liquid is used alone. That in turn increases the humidity-controlling rate.

The water-absorbing material 21 includes at least one species selected from the group consisting of water-absorbing resins and clay minerals.

The water-absorbing resin may be either ionic or nonionic.

The ionic resin includes, for example, at least one species selected from the group consisting of alkali metal salts of polyacrylic acid and starch-acrylate graft polymers. The alkali metal salt of polyacrylic acid includes, for example, sodium polyacrylate.

The nonionic resin includes, for example, at least one species selected from the group consisting of vinyl acetate copolymers, maleic anhydride copolymers, polyvinyl alcohol, and polyalkylene oxides.

The clay mineral includes, for example, at least one species selected from the group consisting of silicate minerals and zeolite. The silicate mineral includes, for example, at least one species selected from the group consisting of sepiolite, attapulgite, kaolinite, perlite, and dolomite.

The humidity-controlling component 12 contains the first salt that has a deliquescence point in the relative humidity range of from 30% RH to 80% RH both inclusive. The first salt deliquescences when the relative humidity of the ambient air is higher than or equal to the deliquescence point. The first salt preferably forms hydrate crystals in the relative humidity range of from 30% RH to 80% RH both inclusive. The first salt has a threshold humidity in the relative humidity range of from 30% RH to 80% RH both inclusive. The first salt crystallizes, thereby being hardly capable of absorbing and releasing moisture, when the relative humidity of the ambient air is lower than the threshold humidity and does not crystallize, thereby being capable of absorbing and releasing moisture, when the relative humidity of the ambient air is higher than the threshold humidity.

The first salt may or may not be a metal salt. The metal salt is, for example, a carboxylate or a carbonate. The carboxylate is, for example, sodium formate, sodium acetate, or sodium propionate. The carbonate is, for example, potassium carbonate.

The humidity-controlling component 12 contains the second salt. When the first salt is composed of first anions and first cations, the second salt is composed of second anions that differ from the first anions and second cations that differ from the first cations. The second salt has a deliquescence point that differs from the deliquescence point of the first salt and preferably has a deliquescence point in the relative humidity range of below 30% RH. The inclusion of the second salt in the humidity-controlling component 12 enables restraining the first salt from crystallizing, thereby being hardly capable of absorbing and releasing moisture, when the relative humidity of the ambient air is lower than the threshold humidity. The humidity-controlling material 1 is hence obtained which exhibits a high humidity-controlling capability even at low humidity.

The second salt may or may not be a metal salt. The metal salt is, for example, a potassium salt. The potassium salt is, for example, potassium lactate, potassium acetate, potassium carbonate, or potassium propionate. The potassium salt has a high solubility to water, hence high hygroscopicity. Therefore, when the second salt is a potassium salt, the first salt can be restrained from crystallizing without having to significantly reducing the humidity-controlling capability of the humidity-controlling component 12.

The second cations are preferably monovalent cations. This is because monovalent cations can more readily penetrate into the water-absorbing material 21 than divalent or higher-valent cations, and when the second cations are monovalent, the water-absorbing material 21 can have an elevated degree of swelling. This effect is particularly evident when the water-absorbing material 21 contains sodium polyacrylate.

The humidity-controlling component 12 may contain components other than the first salt and the second salt. As an example, the humidity-controlling component 12 may contain an additive for adjusting the humidity-controlling capability of the humidity-controlling material 1 in a humidity range. The additive, for example, contains at least one species selected from the group consisting of metal salts other than the first salt and the second salt, water, polyhydric alcohol, and nucleation materials for hydrate crystals of the first salt. In particular, humidity-controlling materials with prescribed equilibrium humidity can be obtained when the additive is water. Specifically, the absorption and desorption of moisture reaches a state of equilibrium at a prescribed relative humidity, by bringing the mass fraction of water in the humidity-controlling material closer to the moisture absorption ratio corresponding to the prescribed relative humidity on the moisture sorption isotherm of the humidity-controlling material containing the first salt and the second salt. Therefore, the humidity-controlling material containing this humidity-controlling component, when placed in a sealed space, works to bring the relative humidity of the space closer to the prescribed relative humidity, which enables keeping the prescribed relative humidity in the space. The mass fraction of water in the humidity-controlling material is, for example, in the range of 10%, preferably ±5%, of the moisture absorption ratio corresponding to the prescribed relative humidity on the moisture sorption isotherm of the humidity-controlling material containing the first salt and the second salt.

The other metal salt includes, for example, at least one species from lithium chloride, calcium chloride, magnesium chloride, sodium benzoate, lithium bromide, calcium bromide, and potassium bromide.

The polyhydric alcohol includes, for example, at least one species selected from the group consisting of glycerin, propanediol, butanediol, pentanediol, trimethylolpropane, butanetriol, ethylene glycol, diethylene glycol, triethylene glycol, and lactic acid and preferably includes a polyhydric alcohol with three or more hydroxy groups. The polyhydric alcohol with three or more hydroxy groups includes, for example, glycerin. The polyhydric alcohol may form a dimer or a polymer.

The nucleation material includes, for example, at least one species selected from the group consisting of carboxylic acids with two or more carboxyl groups and amides with two or more amide groups.

### 1.2 Threshold Humidity of Carboxylate

FIG. 2 is a graph representing moisture sorption isotherms of sodium acetate, sodium propionate, and sodium formate. In this graph, the relative humidity is plotted on the horizontal axis, and the moisture absorption ratio is plotted on the vertical axis. The moisture absorption ratio is obtained by subtracting the initial weight from the post-moisture-absorption weight and dividing the difference by the initial weight. It is understood that the humidity-controlling capability grows higher with an increase in the moisture absorption ratio at the prescribed relative humidity.

The carboxylate used as the first salt, particularly a sodium salt of carboxylic acid, forms rigid hydrate crystals with water molecules when hydrated. The resultant rigid hydrate crystals are further hydrated and then liquidized upon deliquescencing. Huge energy is needed, however, for further hydration of the resultant rigid hydrate crystals. Therefore, the carboxylate is hydrated, thereby forming rigid hydrate crystals with water molecules, when the relative humidity has reached a first relative humidity, and these hydrate crystals are liquidized upon deliquescencing when the relative humidity has reached a second relative humidity that is higher than the first relative humidity. As shown in, for example, FIG. 2, the sodium acetate forms rigid hydrate crystals with water molecules when the relative humidity is lower than or equal to approximately 70% RH, and the hydrate crystals are liquidized upon deliquescencing when the relative humidity has reached approximately 80% RH. The hydrate crystals are a trihydrate. In addition, the sodium propionate and the sodium formate form rigid hydrate crystals with water molecules when the relative humidity is lower than or equal to approximately 50% RH, and the hydrate crystals are liquidized upon deliquescencing when the relative humidity has reached approximately 60% RH.

Therefore, the carboxylate, particularly a sodium salt of carboxylic acid, has a relative humidity at which it forms rigid hydrate crystals with water molecules and/or a threshold humidity, including a deliquescence point, at which it deliquescences and is liquidized. Therefore, in the carboxylate, particularly a sodium salt of carboxylic acid, the absorption of moisture does not proceed beyond a point where the salt can form hydrate crystals with water molecules when the relative humidity of the ambient air is lower than the threshold humidity and, when the relative humidity of the ambient air has exceeded the threshold humidity, the absorption of moisture rapidly proceeds with accompanying rises in the moisture absorption ratio. As shown in, for example, FIG. 2, in sodium acetate, the absorption of moisture does not proceed beyond a point where the sodium acetate can form a trihydrate when the relative humidity of the ambient air is lower than approximately 70 to 80% RH and, when the relative humidity of the ambient air has exceeded approximately 70 to 80% RH, the absorption of moisture rapidly proceeds with accompanying rises in the moisture absorption ratio. In addition, in the sodium propionate and the sodium formate, the absorption of moisture does not proceed beyond a point where the salt can form hydrate crystals when the relative humidity of the ambient air is lower than approximately 50 to 60% RH and, when the relative humidity of the ambient air has exceeded approximately 50 to 60% RH, the absorption of moisture rapidly proceeds with accompanying rises in the moisture absorption ratio.

Therefore, carboxylate exhibits a threshold humidity that acts as a boundary between the relative humidity at which the absorption of moisture hardly proceeds and the relative humidity at which the absorption of moisture rapidly proceeds. As shown in, for example, FIG. 2, sodium acetate exhibits a threshold humidity of approximately from 70 to 80% RH. In addition, sodium propionate and sodium formate exhibit a threshold humidity of approximately from 50 to 60% RH.

### 1.3 Fine Structure of Humidity-controlling Component

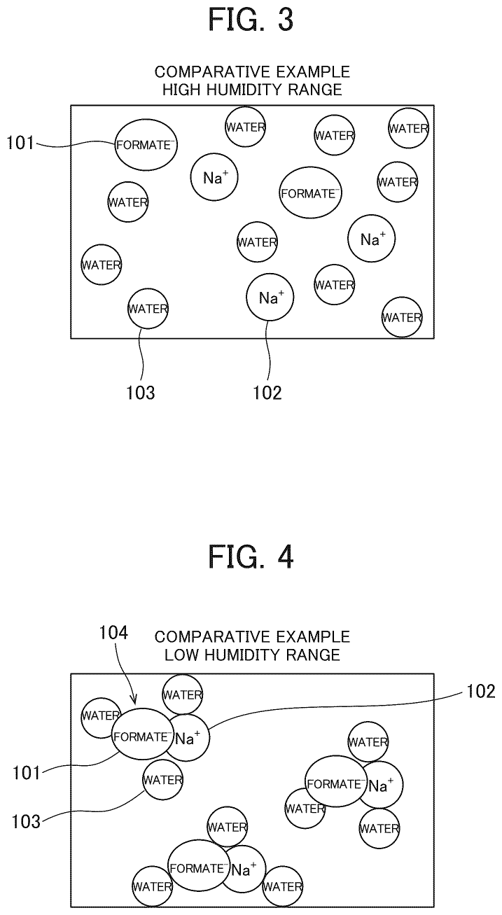

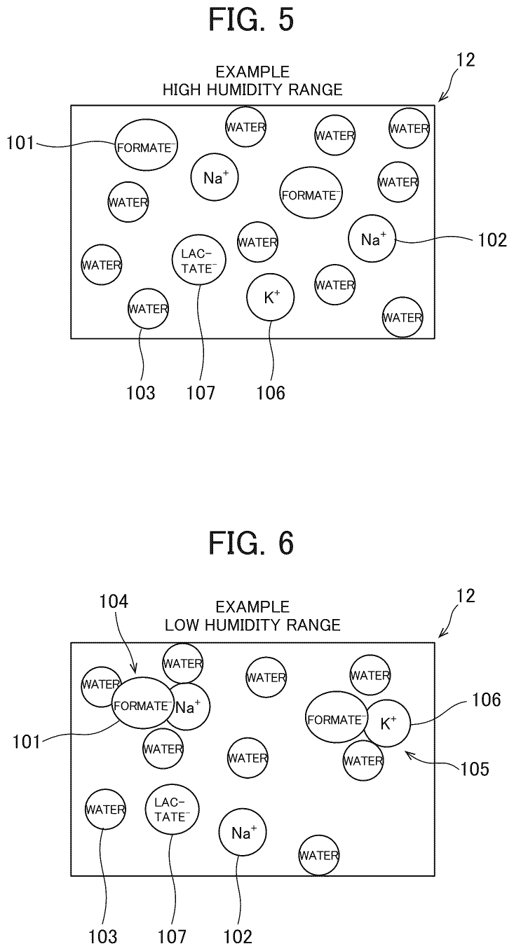

FIGS. 3 and 4 are schematic diagrams of a fine structure of a humidity-controlling component contained in a humidity-controlling material in accordance with a comparative example at high humidity and at low humidity respectively. FIGS. 5 and 6 are schematic diagrams of a fine structure of a humidity-controlling component contained in a humidity-controlling material in accordance with an example at high humidity and at low humidity respectively.

In a humidity-controlling component containing the first salt, but not containing the second salt, no hydrate of the first salt is formed, and the first salt does not crystallize, at high humidity above the deliquescence point of the first salt. Meanwhile, at humidity lower than the deliquescence point of the first salt, a hydrate of the first salt is formed, and the first salt readily crystallizes.

For instance, when the first salt is sodium formate, no hydrate, of sodium formate, that is composed of formate ions 101, sodium ions 102, and water molecules 103 is formed, and sodium formate does not crystallize, at high humidity as shown in FIG. 3. Meanwhile, at low humidity, a hydrate 104, of sodium formate, that is composed of formate ions 101, sodium ions 102, and water molecules 103 is formed, and sodium formate readily crystallizes, as shown in FIG. 4.

Therefore, the humidity-controlling component exhibits a high humidity-controlling capability at high humidity, but only exhibits a low humidity-controlling capability at low humidity.

In contrast, in the humidity-controlling component 12 containing the first salt and the second salt, no hydrate of the first salt is formed, and the first salt does not crystallize, at high humidity. In addition, at low humidity, a hydrate of the first salt and another hydrate that differs from this hydrate of the first salt are formed, and the first salt does not readily crystallize.

The other hydrate that differs from the hydrate of the first salt is generated by ion exchange of the first cations in the first salt and the second cations in the second salt and/or by ion exchange of the first anions in the first salt and the second anions in the second salt. The formation of a hydrate of the first salt and another hydrate that differs from this hydrate of the first salt renders the first salt not readily crystallize because the types of generated crystals increases so that different types of crystals have a complex composition ratio.

For instance, when the first salt is sodium formate, and the second salt is potassium lactate, no hydrate of sodium formate is formed, and sodium formate does not crystallize, at high humidity as shown in FIG. 5. In addition, at low humidity, a hydrate 105, of potassium formate, that is composed of formate ions 101, potassium ions 106, and water molecules 103, a hydrate, of potassium lactate, that is composed of lactate ions 107, potassium ions 106, and water molecules 103, and a hydrate, of sodium lactate, that is composed of lactate ions 107, sodium ions 102, and water molecules 103 are formed in addition to the hydrate 104 of sodium formate, and sodium formate does not readily crystallize, as shown in FIG. 6.

Therefore, the humidity-controlling component 12 exhibits a high humidity-controlling capability at high humidity and also at low humidity.

Potassium formate and sodium lactate are generated by ion exchange of the sodium ions 102 in sodium formate and the potassium ions 106 in potassium lactate and/or by ion exchange of the formate ions 101 in sodium formate and the lactate ions 107 in potassium lactate. The formation of a hydrate 104 of sodium formate, a hydrate 105 of potassium formate, a hydrate of potassium lactate, and a hydrate of sodium lactate renders the sodium formate not readily crystallize because the types of generated crystals increases so that different types of crystals have a complex composition ratio. In addition, potassium formate and sodium lactate exhibit a high solubility in water and dissolve in water even when the water molecules 103 are relatively few in number. This also renders the hydrate 104 of sodium formate less likely to be formed, thereby causing sodium formate to less likely crystallize.

### 1.4 Moisture Sorption Isotherm of Humidity-controlling Component

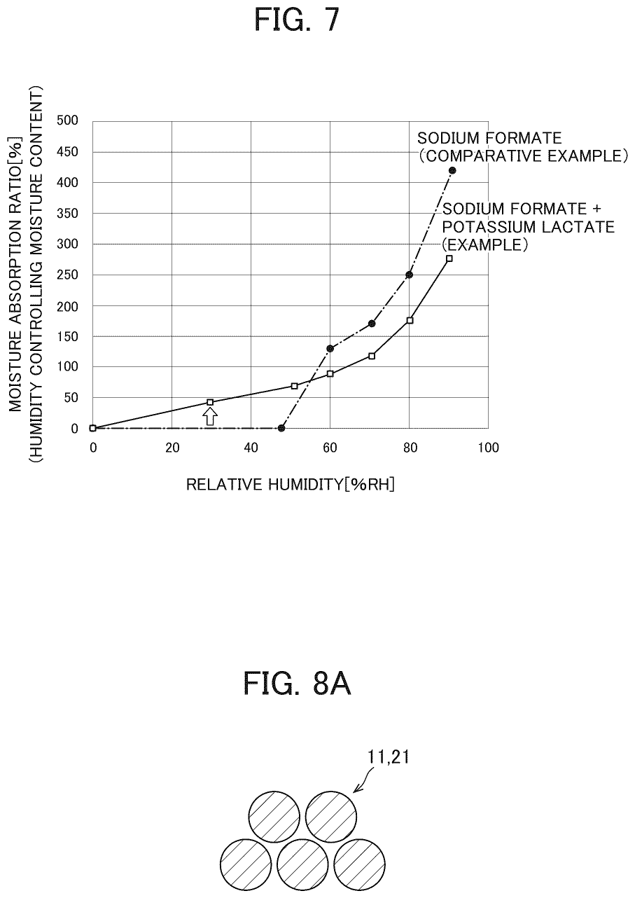

FIG. 7 is a graph representing moisture sorption isotherms of the humidity-controlling component contained in a humidity-controlling material in accordance with a comparative example and the humidity-controlling component contained in a humidity-controlling material in accordance with an example. In the graph shown in FIG. 7, the relative humidity is plotted on the horizontal axis, and the moisture absorption ratio is plotted on the vertical axis.

In a humidity-controlling component containing the first salt, but not containing the second salt, the moisture absorption ratio abruptly increases with an increase in the relative humidity at high humidity, but the moisture absorption ratio is extremely low at low humidity.

For instance, when the first salt is sodium formate, the moisture absorption ratio abruptly increases with an increase in the relative humidity at relative humidity in the range of approximately from 50 to 100% RH, but the moisture absorption ratio is extremely low at relative humidity in the range of approximately from 0 to 50% RH, as shown in FIG. 7. Therefore, this humidity-controlling component exhibits a high humidity-controlling capability at relative humidity in a range of approximately from 50 to 100% RH, but only exhibits a low humidity-controlling capability at relative humidity in the range of approximately from 0 to 50% RH.

In contrast, in the humidity-controlling component 12 containing the first salt and the second salt, the moisture absorption ratio gradually increases with an increase in the relative humidity both at high humidity and at low humidity.

For instance, when the first salt is sodium formate, and the second salt is potassium lactate, the moisture absorption ratio gradually increases with an increase in the relative humidity both at low relative humidity in the range of approximately from 0 to 50% RH and at high relative humidity in the range of approximately from 50 to 100% RH, as shown in FIG. 7. Therefore, the humidity-controlling component 12 exhibits a high humidity-controlling capability both at relative humidity in the range of approximately from 0 to 50% RH and at relative humidity in the range of approximately from 50 to 100% RH.

### 1.5 Method of Manufacturing Humidity-controlling Material

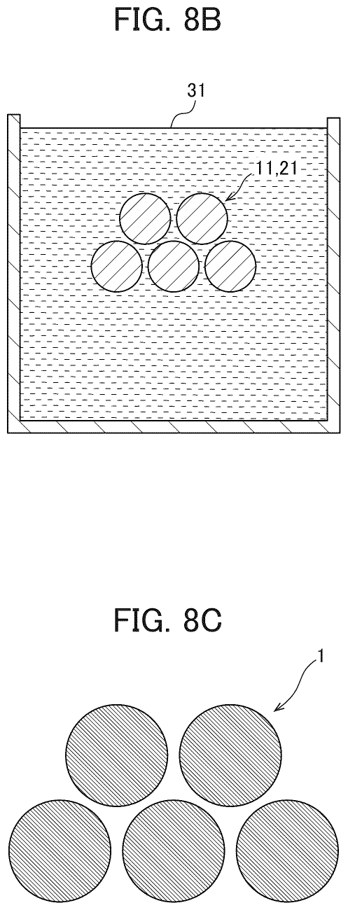

FIGS. 8A, 8B, and 8C are schematic diagrams illustrating a method of manufacturing a humidity-controlling material in accordance with Embodiment 1.

The water-absorbing bodies 11 are prepared in the manufacture of the humidity-controlling material 1 as shown in FIG. 8A.

Subsequently, a humidity-controlling liquid 31 is prepared as shown in FIG. 8B. The humidity-controlling liquid 31 to be prepared contains the first salt and the second salt. In addition, the prepared water-absorbing bodies 11 are immersed in the prepared humidity-controlling liquid 31. The water-absorbing bodies 11 are immersed in the humidity-controlling liquid 31 for a duration of, for example, from a few hours to 24 hours. Hence, the humidity-controlling liquid 31 permeates the water-absorbing bodies 11, thereby forming the humidity-controlling material 1. The humidity-controlling liquid 31, upon the permeation, becomes the humidity-controlling component 12 contained in the humidity-controlling material 1. In addition, the humidity-controlling liquid 31 to be prepared may be the first salt and the second salt dissolved in water. Hence, a humidity-controlling material can be obtained that has a prescribed equilibrium humidity. First, for example, the moisture absorption ratio upon a prescribed relative humidity is read out from the moisture sorption isotherm of the moisture absorption ratio with respect to the relative humidity shown in, for example, FIG. 7, and water is added so that the ratio of the weight of the first salt and the second salt and water is equal to the moisture absorption ratio. Hence, a humidity-controlling liquid can be obtained that has a prescribed equilibrium humidity. At this stage, if the moisture absorption ratio is within +10% of the reading of the moisture sorption isotherm, the humidity-controlling liquid can substantially retain a prescribed equilibrium humidity. By causing the water-absorbing material to permeate the humidity-controlling liquid, a humidity-controlling material can be obtained that has a prescribed equilibrium humidity. The humidity-controlling material with a prescribed equilibrium humidity acts so as to bring the relative humidity of the space in which humidity-controlling material is placed closer to the prescribed equilibrium humidity, thereby enabling retaining the prescribed equilibrium humidity.

Subsequently, the formed humidity-controlling material 1 is pulled out of the remaining humidity-controlling liquid 31 as shown in FIG. 8C. The humidity-controlling material 1, when pulled out, has swollen by, for example, 2 to 20 folds.

### 1.6 Restraining Metal Corrosion

Table 1 shows, in relative value, the metal corrosion quantities of CMA, an acetate compound, and sodium formate, all of which contain no chloride, and of sodium chloride, calcium chloride, magnesium chloride, and an acetate compound, all of which contain chloride. CMA stands for calcium magnesium acetate. The chloride-containing acetate compound is a mixture of sodium chloride and an acetate compound containing no chloride.

TABLE 1

| | | Metal Corrosion |
|---|---|---|
| Presence/absence | | Quantity |
| of Chloride | Substance | (Relative Value) |
| Contains No | CMA (Calcium Magnesium | 0.004 |
| Chloride | Acetate) | |
| | Acetate Compound | 0.003 |
| | Sodium Formate | 0.012 |
| Contains Chloride | Sodium Chloride | 1 |
| | Calcium Chloride | 1.5 |
| | Magnesium Chloride | 1.3 |
| | Acetate Compound (Acetate | 0.15 |
| | Compound + Sodium Chloride) | |

It can be understood from Table 1 that the metal corrosion quantities of CMA, the acetate compound, and sodium formate, all of which contain no chloride are remarkably lower than the metal corrosion quantities of sodium chloride, calcium chloride, magnesium chloride, and the acetate compound, all of which contain chloride.

It can also be understood from Table 1 that the metal corrosion quantity of the chloride-containing acetate compound is lower than the metal corrosion quantities of sodium chloride, calcium chloride, and magnesium chloride, all of which contain chloride.

These facts demonstrate that the metal corrosion quantity of the humidity-controlling component 12, which contains a carboxylate as a main component, such as CMA, the acetate compound, or sodium formate, is lower than the metal corrosion quantity of humidity-controlling components that contain chloride as a main component.

Therefore, the humidity-controlling material 1 containing the humidity-controlling component 12, which contains a carboxylate as a main component, is unlikely to cause, for example, metal rust and can be used in many applications. The humidity-controlling material 1 can be used, for example, for humidity control and storage of various metal-containing articles of taste including musical instruments and cameras, and for prevention of dew condensation in electrical component boxes and shipping containers.

### 1.7 Combination of Sodium Formate and Potassium Lactate

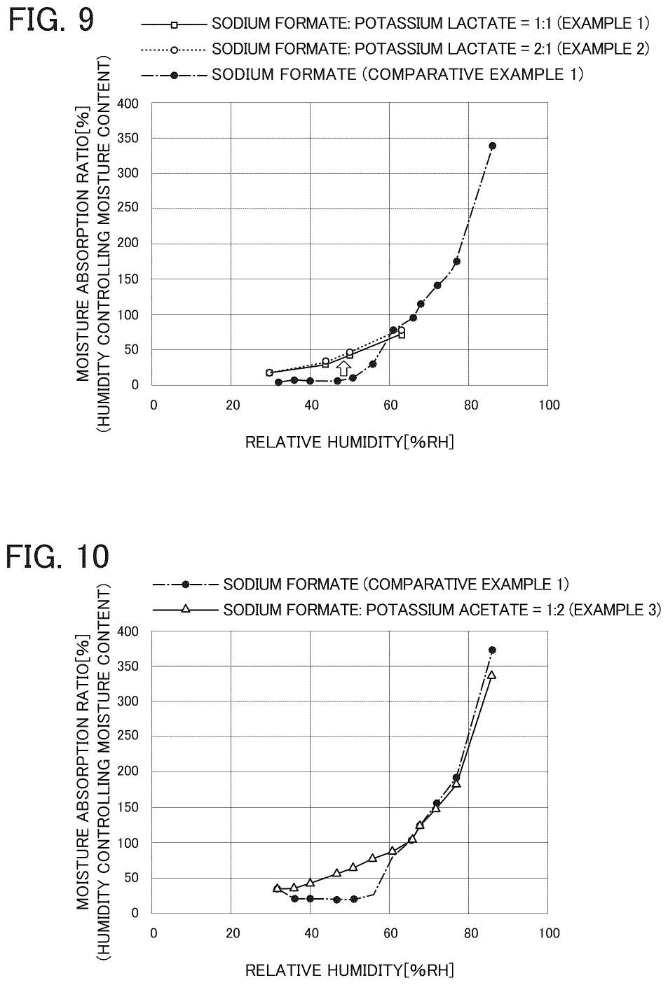

FIG. 9 is a graph representing moisture sorption isotherms of a humidity-controlling material in accordance with Example 1, a humidity-controlling material in accordance with Example 2, and a humidity-controlling material in accordance with Comparative Example 1. This graph shows moisture sorption isotherms of humidity-controlling materials with large particle diameters. In the graph, the relative humidity is plotted on the horizontal axis, and the moisture absorption ratio is plotted on the vertical axis.

A humidity-controlling material 1 in accordance with Example 1 contains a humidity-controlling component 12 containing 1 part by weight of sodium formate as the first salt and containing 1 part by weight of potassium lactate as the second salt. A humidity-controlling material 1 in accordance with Example 2 contains a humidity-controlling component 12 containing 2 parts by weight of sodium formate as the first salt and containing 1 part by weight of potassium lactate as the second salt. A humidity-controlling material in accordance with Comparative Example 1 contains a humidity-controlling component containing sodium formate as the first salt, but not containing the second salt. It can be understood from FIG. 9 that the moisture absorption ratios of the humidity-controlling material 1 in accordance with Example 1 and the humidity-controlling material 1 in accordance with Example 2 that contain the humidity-controlling component 12 containing sodium formate as the first salt and containing potassium lactate as the second salt are higher than the moisture absorption ratio of the humidity-controlling material in accordance with Comparative Example 1 that contain a humidity-controlling component containing sodium formate the first salt, but not containing the second salt at low relative humidity in the range of from 35% RH to 55% RH both inclusive. In addition, from the data shown in FIG. 9, the rate of change of the moisture weight of the humidity-controlling material 1 in accordance with Example 1 at low humidity can be calculated as being approximately 33%, the rate of change of the moisture weight of the humidity-controlling material 1 in accordance with Example 2 at low humidity can be calculated as being approximately 34%, and the rate of change of the moisture weight of the humidity-controlling material in accordance with Comparative Example 1 at low humidity can be calculated as being approximately 4.2%. It is understood from these results that the mixing of potassium lactate to sodium formate can increase the rate of change of moisture weight at low humidity and improve the humidity-controlling capability at low humidity. Note that the rate of change of moisture may be calculated as in the following. On the moisture sorption isotherm of the moisture absorption ratio with respect to the relative humidity shown in FIG. 9, a moisture content weight G₁, which is the moisture content of the humidity-controlling material at a prescribed relative humidity H₁, is obtained from the moisture absorption ratio upon the relative humidity H_{1+α} Next, a moisture content weight G_{1+α} upon a relative humidity H_{1+α} is obtained from a moisture absorbing ratio upon H_{1+α} which is a slightly lower humidity than the relative humidity H₁, and a moisture content weight G_{1+α} upon a relative humidity H_{1+α} is obtained from a moisture absorbing ratio upon H_{1+α} which is a slightly higher humidity than the relative humidity H_{1+α} The rate of change of moisture weight is obtained by subtracting G_{1+α} from G_{1+α} and dividing by a sum of G₁ and the dry weight of the humidity-controlling material (relative humidity 0% RH). In other words, the rate of change of moisture weight indicates a tolerance for, for example, a moisture increase in absorbing moisture or a moisture decrease in desorbing moisture at the prescribed the relative humidity H₁: the larger the rate of change of moisture weight is, the higher the retaining capability is at the prescribed relative humidity. It is therefore understood that the humidity-controlling material 1 in accordance with Example 1 and the humidity-controlling material 1 in accordance with Example 2 exhibit A higher retaining capability at a prescribed relative humidity at low humidity in the range of from 35% RH to 55% RH both inclusive than the humidity-controlling material in accordance with Comparative Example 1.

### 1.8 Combination of Sodium Formate and Potassium Acetate

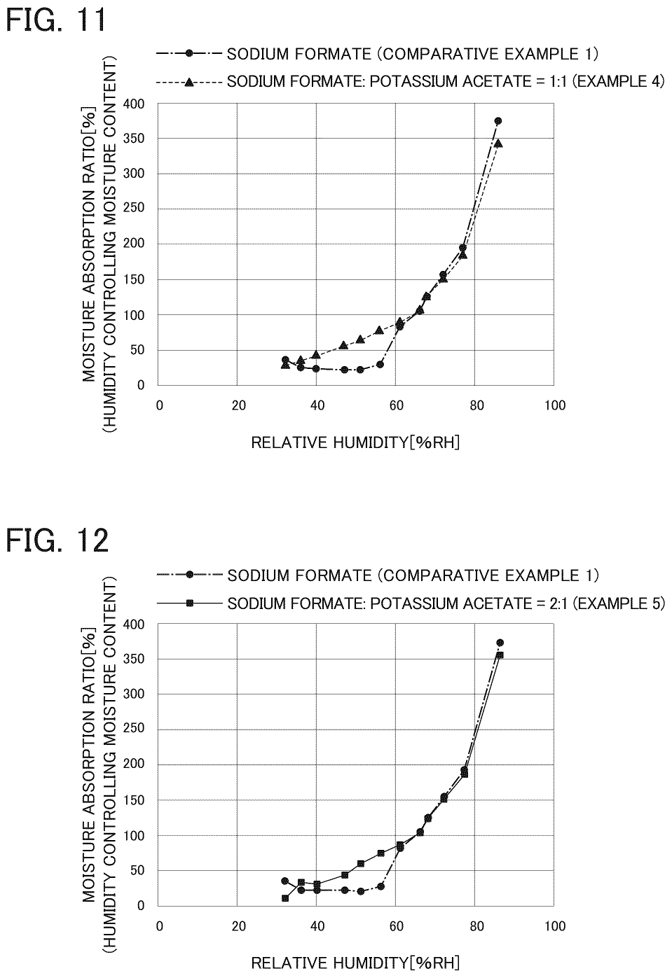

FIG. 10 is a graph representing moisture sorption isotherms of a humidity-controlling material in accordance with Example 3 and a humidity-controlling material in accordance with Comparative Example 1. FIG. 11 is a graph representing moisture sorption isotherms of a humidity-controlling material in accordance with Example 4 and a humidity-controlling material in accordance with Comparative Example 1. FIG. 12 is a graph representing moisture sorption isotherms of a humidity-controlling material in accordance with Example 5 and a humidity-controlling material in accordance with Comparative Example 1. These graphs show moisture sorption isotherms of humidity-controlling materials with large particle diameters. In the graphs, the relative humidity is plotted on the horizontal axis, and the moisture absorption ratio is plotted on the vertical axis.

A humidity-controlling material 1 in accordance with Example 3 contains a humidity-controlling component 12 containing 1 part by weight of sodium formate as the first salt and containing 2 parts by weight of potassium acetate as the second salt. A humidity-controlling material 1 in accordance with Example 4 contains a humidity-controlling component 12 containing 1 part by weight of sodium formate as the first salt and containing 1 part by weight of potassium acetate as the second salt. A humidity-controlling material 1 in accordance with Example 5 contains a humidity-controlling component 12 containing 2 parts by weight of sodium formate as the first salt and containing 1 part by weight of potassium acetate as the second salt. The humidity-controlling material in accordance with Comparative Example 1 contains a humidity-controlling component sodium formate as the first salt, but not containing the second salt. It is understood from FIGS. 10, 11, and 12 that at low relative humidity in the range of from 35% RH to 55% RH both inclusive, the moisture absorption ratios of the humidity-controlling material 1 in accordance with Example 3, the humidity-controlling material 1 in accordance with Example 4, and the humidity-controlling material 1 in accordance with Example 5, all of which contain a humidity-controlling component 12 containing sodium formate as the first salt and containing potassium acetate as the second salt, are higher than the moisture absorption ratio of the humidity-controlling material in accordance with Comparative Example 1 that contains a humidity-controlling component containing sodium formate as the first salt, but not containing the second salt. In addition, from the data shown in FIGS. 10, 11, and 12, the rate of change of the moisture weight of the humidity-controlling material 1 in accordance with Example 3 at low humidity can be calculated as being approximately 25.3%, the rate of change of the moisture weight of the humidity-controlling material 1 in accordance with Example 4 at low humidity can be calculated as being approximately 26.3%, the rate of change of the moisture weight of the humidity-controlling material 1 in accordance with Example 5 at low humidity can be calculated as being approximately 27.3%, and the rate of change of the moisture weight of the humidity-controlling material in accordance with Comparative Example 1 can be calculated as being approximately 4.2%. It is understood from these results that the mixing of potassium acetate to sodium formate can increase the rate of change of moisture weight at low humidity and improve the humidity-controlling capability at low humidity. In other words, the relative humidity retaining capability is high at low humidity because the rate of change of moisture weight is high at low humidity, as described earlier.

### 1.9 Combination of Sodium Formate and Potassium Carbonate

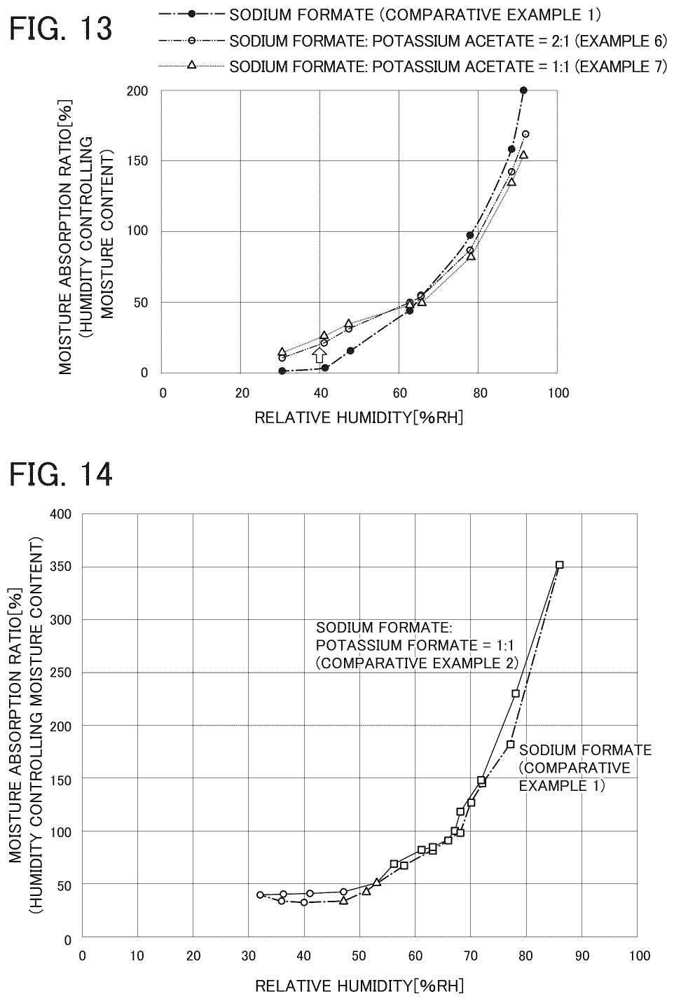

FIG. 13 is a graph representing moisture sorption isotherms of a humidity-controlling material in accordance with Example 6, a humidity-controlling material in accordance with Example 7, and a humidity-controlling material in accordance with Comparative Example 1. This graph shows moisture sorption isotherms of humidity-controlling materials with small particle diameters. In the graph, the relative humidity is plotted on the horizontal axis, and the moisture absorption ratio is plotted on the vertical axis.

A humidity-controlling material 1 in accordance with Example 6 contains a humidity-controlling component 12 containing 2 parts by weight of sodium formate as the first salt and containing 1 part by weight of potassium carbonate as the second salt. A humidity-controlling material 1 in accordance with Example 7 contains a humidity-controlling component 12 containing 1 part by weight of sodium formate as the first salt and containing 1 part by weight of potassium carbonate as the second salt. A humidity-controlling material in accordance with Comparative Example 1 contains a humidity-controlling component containing sodium formate as the first salt, but not containing the second salt. It is understood from FIG. 13 that at low relative humidity in the range of from 35% RH to 55% RH both inclusive, the moisture absorption ratios of the humidity-controlling material 1 in accordance with Example 6 and the humidity-controlling material 1 in accordance with Example 7, both of which contain a humidity-controlling component 12 containing sodium formate as the first salt and containing potassium carbonate as the second salt, are higher than the moisture absorption ratio of the humidity-controlling material in accordance with Comparative Example 1 that contains a humidity-controlling component containing sodium formate as the first salt, but not containing the second salt. It is understood from these results that the mixing of potassium carbonate to sodium formate can increase the rate of change of moisture weight at low humidity and improve the humidity-controlling capability at low humidity. In addition, it is understood that the humidity-controlling capability can be improved at low humidity irrespective of the particle diameters of the humidity-controlling material 1. In other words, the relative humidity retaining capability is high at low humidity because the rate of change of moisture weight is high at low humidity, as described earlier.

### 1.10 Combination of Sodium Formate and Potassium Formate

FIG. 14 is a graph representing moisture sorption isotherms of a humidity-controlling material in accordance with Comparative Example 1 and a humidity-controlling material in accordance with Comparative Example 2. This graph shows moisture sorption isotherms of humidity-controlling materials with large particle diameters. In this graph, the relative humidity is plotted on the horizontal axis, and the moisture absorption ratio is plotted on the vertical axis. In this graph, circular plotted points denote that the humidity-controlling material has crystallized and is cloudy, quadrilateral plotted points denote that the humidity-controlling material has not crystallized and is not cloudy, and triangle plotted points denote that the humidity-controlling material is somewhere between these two conditions.

The humidity-controlling material in accordance with Comparative Example 1 contains a humidity-controlling component containing sodium formate as the first salt, but not containing the second salt. The humidity-controlling material in accordance with Comparative Example 2 contains a humidity-controlling component containing 1 part by weight of sodium formate as the first salt and containing 1 part by weight of potassium formate as the second salt. It is understood FIG. 14 that at low relative humidity in the range of from 50% RH to 55% RH both inclusive, which is the crystallization humidity, the moisture absorption ratio of the humidity-controlling material in accordance with Comparative Example 2 that contains a humidity-controlling component containing sodium formate as the first salt and containing potassium formate as the second salt is approximately equal to the moisture absorption ratio of the humidity-controlling material in accordance with Comparative Example 1 that contains a humidity-controlling component containing sodium formate as the first salt, but not containing the second salt. It is understood from these results that the mixing of potassium formate to sodium formate cannot increase the rate of change of moisture weight at low humidity and cannot improve the humidity-controlling capability at low humidity. This indicates that potassium formate, which contains the same species of anions as the anions contained in sodium formate, cannot restrain crystallization of sodium formate.

### 1.11 Other Examples of Water-absorbing Bodies

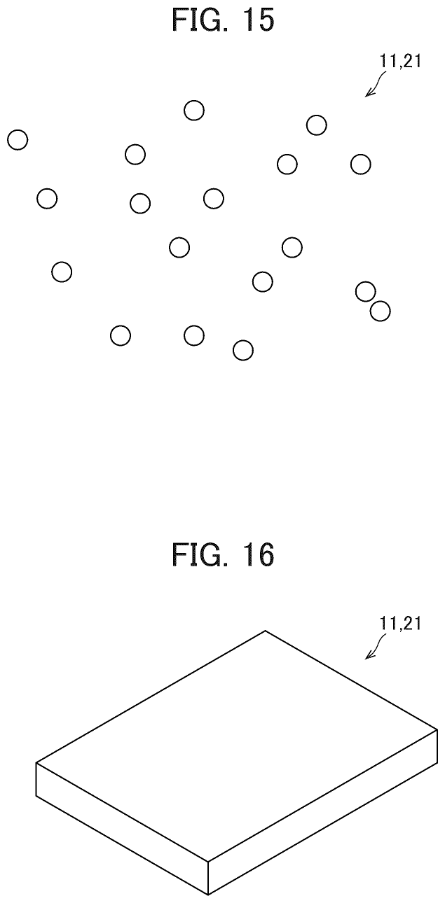

FIG. 15 is a schematic plan view of a first alternative example of water-absorbing bodies contained in the humidity-controlling material in accordance with Embodiment 1.

The water-absorbing bodies 11 shown in FIG. 15 are in powder form. The water-absorbing bodies shown in FIG. 15 have, for example, a diameter of from a few micrometers to a few millimeters.

FIG. 16 is a schematic perspective view of a second alternative example of the water-absorbing body contained in the humidity-controlling material in accordance with Embodiment 1.

The water-absorbing body 11 shown in FIG. 16 is in sheet form.

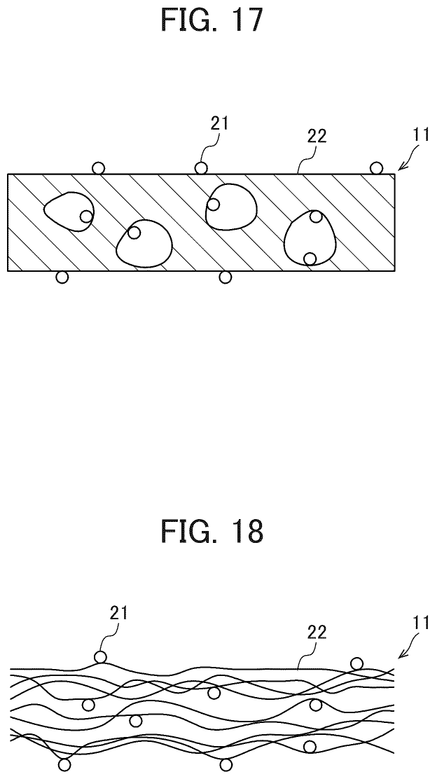

FIG. 17 is a schematic cross-sectional view of a third alternative example of the water-absorbing body contained in the humidity-controlling material in accordance with Embodiment 1.

The water-absorbing body 11 shown in FIG. 17 contains a water-absorbing material 21 and a support 22. In the water-absorbing body 11 shown in FIG. 17, the water-absorbing material 21 is in either powder or particulate form. In addition, the support 22 is a porous body. The porous body is a foamed body. In addition, the water-absorbing material 21 is supported by the support 22. The water-absorbing material 21 exhibits improved dispersibility due to the water-absorbing material 21 being supported by the support 22. Hence, the area of the interface between the water-absorbing material 21 and air can be increased, which enables increasing the humidity-controlling rate of the humidity-controlling material 1. This effect is particularly evident when the support 22 is a porous body. When the porous body constituting the support 22 is a foamed body, the support 22 has high stiffness. Hence, the humidity-controlling material 1 exhibits a stable shape. The support 22 may be impregnated with a humidity-controlling liquid.

FIG. 18 is a schematic cross-sectional view of a fourth alternative example of the water-absorbing body contained in the humidity-controlling material in accordance with Embodiment 1.

The water-absorbing body 11 shown in FIG. 18 contains a water-absorbing material 21 and a support 22. In the water-absorbing body 11 shown in FIG. 18, the water-absorbing material 21 is in either powder or particulate form. In addition, the support 22 is a porous body. The porous body is a nonwoven fabric or a woven fabric. In addition, the water-absorbing material 21 is supported by the support 22. The water-absorbing material 21 exhibits improved dispersibility due to the water-absorbing material 21 being supported by the support 22. Hence, the area of the interface between the water-absorbing material 21 and air can be increased, which enables increasing the humidity-controlling rate of the humidity-controlling material 1. This effect is particularly evident when the support 22 is a porous body. When the porous body constituting the support 22 is either a nonwoven fabric or a woven fabric, the support 22 is flexible. Therefore, the support 22 can be deformed. The support 22 may be impregnated with a humidity-controlling liquid.

FIG. 19 is a schematic cross-sectional view of a fifth alternative example of the water-absorbing body contained in the humidity-controlling material in accordance with Embodiment 1.

The water-absorbing body 11 shown in FIG. 19 contains a water-absorbing material 21 and a support 22. In the water-absorbing body 11 shown in FIG. 19, the water-absorbing material 21 is in either powder or particulate form. In addition, the support 22 is a ventilation member that allows air currents to pass in a direction perpendicular to the cross-section shown in FIG. 19. The ventilation member includes, for example, a corrugated nonwoven fabric. In addition, the water-absorbing material 21 is supported by the support 22. The water-absorbing material 21 exhibits improved dispersibility due to the water-absorbing material 21 being supported by the support 22. Hence, the area of the interface between the water-absorbing material 21 and air can be increased, which enables increasing the humidity-controlling rate of the humidity-controlling material 1. According to the water-absorbing body 11 shown in FIG. 19, the water-absorbing material 21 supported by the ventilation member can be efficiently brought into contact with air by passing air currents through the ventilation member, thereby enabling the water-absorbing material 21 to efficiently absorb and release moisture. The water-absorbing body shown in FIG. 19 may be incorporated into a rotational body. The support 22 may be impregnated with a humidity-controlling liquid.

### 1.12 Method of Manufacturing Humidity-controlling Material in Sheet Form

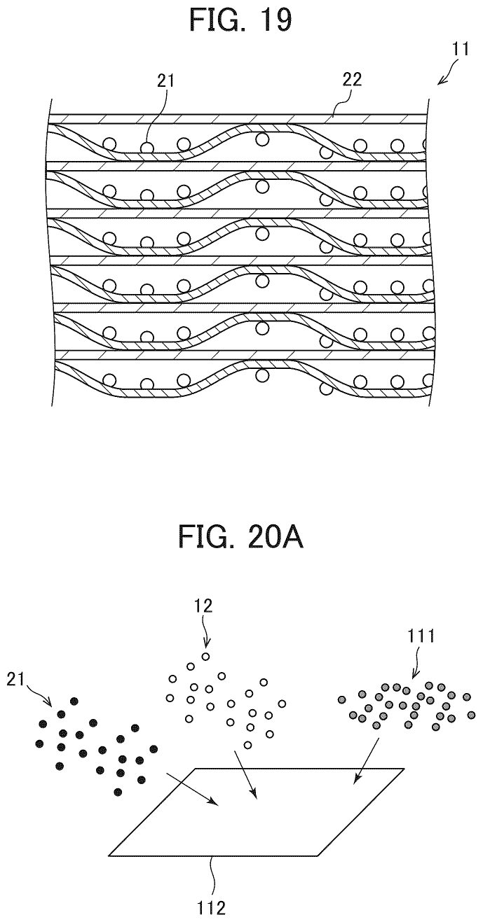

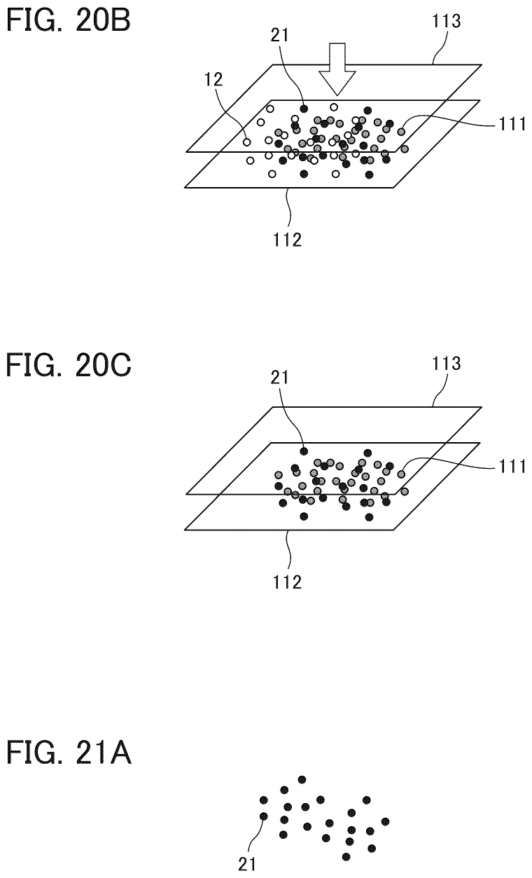

FIGS. 20A to 20C are schematic diagrams illustrating a first method of manufacturing a humidity-controlling material in accordance with Embodiment 1 when this humidity-controlling material is in sheet form.

The first manufacturing method can be employed when the first salt and the second salt are solid. For example, the first manufacturing method can be employed when the first salt is sodium formate, and the second salt is potassium carbonate.

In the first manufacturing method, as shown in FIG. 20A, the water-absorbing material 21 in particulate form, the humidity-controlling component 12, and ethylene-vinyl acetate copolymer (EVA) 111 are dispersed on a first sheet 112. In doing so, the water-absorbing material 21, the humidity-controlling component 12, and the EVA 111 are sufficiently distributed.

Subsequently, as shown in FIG. 20B, a second sheet 113 is placed over the first sheet 112 so as to overlap the water-absorbing material 21, the humidity-controlling component 12, and the EVA 111. In addition, the first sheet 112 and the second sheet 113 are thermocompressed to each other.

Subsequently, as shown in FIG. 20C, upon the humidity-controlling component 12 absorbing moisture for the first time, the humidity-controlling component 12, together with the moisture absorbed by the humidity-controlling component 12, penetrates into the water-absorbing material 21 and stays inside the water-absorbing material 21.

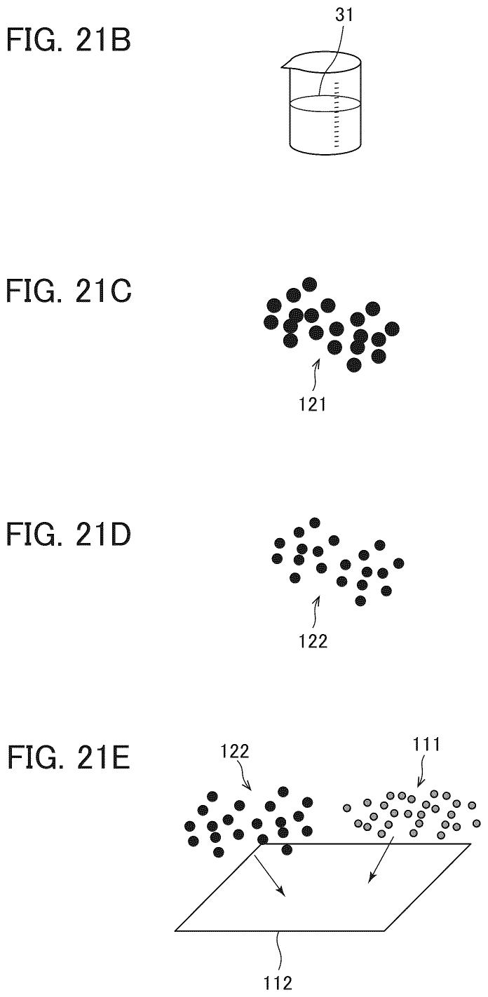

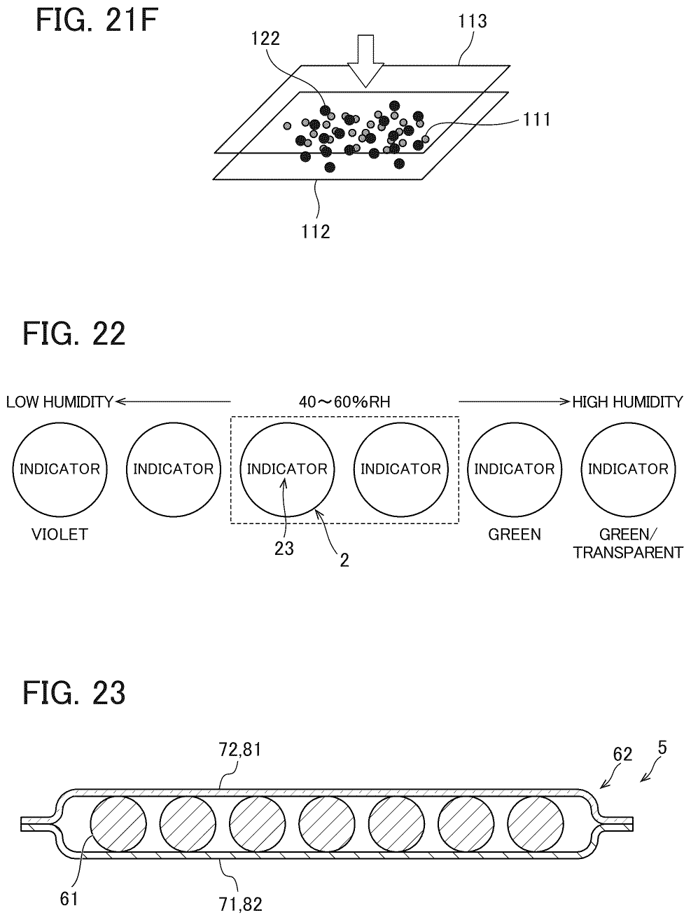

FIGS. 21A to 21F are schematic diagrams illustrating a second method of manufacturing a humidity-controlling material in accordance with Embodiment 1 when this humidity-controlling material is in sheet form.

The second manufacturing method can be employed also when the first salt and the second salt are dissolved in a solvent such as water and are not solid.

In the second manufacturing method, the humidity-controlling liquid 31 is prepared by preparing the water-absorbing material 21 as shown in FIG. 21A and, for example, dissolving the first salt and the second salt in water as shown in FIG. 21B.

Subsequently, as shown in FIG. 21C, the prepared water-absorbing material 21 is immersed in the prepared humidity-controlling liquid 31, and the humidity-controlling liquid 31 permeates the water-absorbing material 21, to produce humidity-controlling powder 121. The produced humidity-controlling powder 121 exhibits, for example, an equilibrium humidity of 60% RH. Note that humidity-controlling powder with an equilibrium humidity of 60% RH can be obtained by the following procedures. First, for example, the moisture absorption ratio upon a relative humidity of 60% RH is read from a moisture sorption isotherm of a moisture absorption ratio with respect to the relative humidity shown in, for example, FIG. 7, and water is added so that the ratio of the weight of the first salt and the second salt and water is equal to the proportion of a moisture absorption ratio. Hence, a humidity-controlling liquid with an equilibrium humidity of 60% RH is obtained. Humidity-controlling powder is obtained by causing a water-absorbing material to permeate this.

Subsequently, as shown in FIG. 21D, humidity-controlling powder 122 for dispersion is produced by stirring and also drying the produced humidity-controlling powder 121.

Subsequently, as shown in FIG. 21E, the produced humidity-controlling powder 122 and the EVA 111 are dispersed on the first sheet 112. In doing so, the humidity-controlling powder 122 and the EVA 111 are sufficiently distributed.

Subsequently, as shown in FIG. 21F, the second sheet 113 is placed over the first sheet 112 so as to overlap the humidity-controlling powder 122 and the EVA 111. In addition, the first sheet 112 and the second sheet 113 are thermocompressed to each other.

The first manufacturing method can employed only when the first salt and the second salt are solid, but advantageously allows omitting the step of producing the humidity-controlling powder 122.

### 2 Embodiment 2

The following description will focus on differences of Embodiment 2 from Embodiment 1. The description may be silent about some structures and features that are common to Embodiment 1 and Embodiment 2.

FIG. 1 is also a schematic cross-sectional view of a humidity-controlling material in accordance with Embodiment 2. FIG. 22 is a schematic diagram of exemplary changes in the color of the humidity-controlling material in accordance with Embodiment 2.

A humidity-controlling material 2 in accordance with Embodiment 2 contains an indicator 23 as shown in FIG. 22. The indicator 23 takes on a color that changes with the moisture content of the humidity-controlling component 12. Hence, the humidity-controlling material 2 is endowed with an indicator function to indicate controlled humidity by color.

The indicator 23 contains, for example, a pH indicator. The pH indicator can be used as the indicator 23 because the humidity-controlling component 12 has a pH value that changes with the moisture content of the humidity-controlling component 12.

The pH indicator is, for example, at least one species selected from the group consisting of bromocresol green, methyl orange, methyl red, methyl purple, methylene blue, bromocresol purple, bromothymol blue, bromophenol blue, chlorophenol red, neutral red, phenol red, cresol red, curcumin, phenol phthalein, α-naphthol phthalein, thymol phthalein, and alizarin yellow.

The humidity-controlling material 2 may contain two or more pH indicators. The two or more pH indicators preferably change their colors at different pH. Hence, the variation of the changes in color of the humidity-controlling material 2 with a change in pH can be increased. Hence, it is possible to more rigorously check the controlled humidity.

In the example shown in FIG. 22, the humidity-controlling material 2 turns into violet when the relative humidity, as indicated by the indicator 23, falls below the 40 to 60% RH range and turns into green and then becomes transparent when the relative humidity rises above the 40 to 60% RH range. Depending on the type of the indicator 23, the color of the humidity-controlling material 2 changes into yellow when the relative humidity falls below the 60 to 70% RH range, changes into green when the relative humidity is in the 60 to 70% RH range, and changes into blue when the relative humidity rises above the 60 to 70% RH range. In addition, depending on the type of the indicator 23, the color of the humidity-controlling material 2 changes into violet when the relative humidity falls below the 60 to 70% RH range, changes into gray when the relative humidity is in the 60 to 70% RH range, and changes into green when the relative humidity rises above the 60 to 70% RH range. Depending on the type of the indicator 23, the color of the humidity-controlling material 2 exhibits changes that differ from these changes.

### 3 Embodiment 3

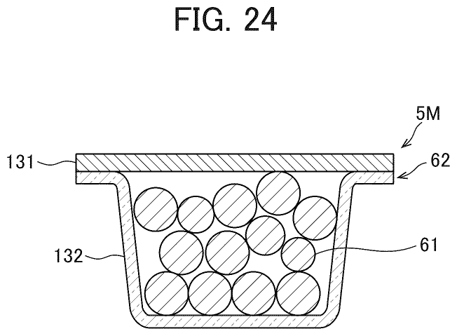

FIG. 23 is a schematic cross-sectional view of a humidity-controlling material with a packaging member in accordance with Embodiment 3.

A humidity-controlling material 5 with a packaging member shown in FIG. 23 includes a humidity-controlling material 61 and a packaging member 62.

The humidity-controlling material 61 is either one of the above-described humidity-controlling materials 1 and 2.

The packaging member 62 is permeable to moisture. The packaging member 62 wraps the humidity-controlling material 61.

This particular structure enables restraining the humidity-controlling material 61 from coming into direct contact with a humidity-control target and also enables the humidity-controlling material 61 to control the humidity of the humidity-control target.

The packaging member 62 is a soft case that is flexible and in bag form. The packaging member 62 may be a packaging member other than a soft case.

The packaging member 62 includes a moisture-permeable membrane 71 and a light transmittance film 72. The moisture-permeable membrane 71 is permeable to moisture. The moisture-permeable membrane 71 is, for example, a polyester nonwoven fabric. The light transmittance film 72 is transparent to light. The light transmittance film 72 is, for example, a polyethylene terephthalate film. The light transmittance film 72 enables visual observation of the condition of the humidity-controlling material 61. Especially, when the humidity-controlling material 61 is the humidity-controlling material 2 that has an indicator function, one can visually recognize, through the light transmittance film 72, the color achieved by the indicator function.

The packaging member 62 includes a front face material 81 and a back face material 82. In Embodiment 4, the front face material 81 is the light transmittance film 72, and the back face material 82 is the moisture-permeable membrane 71. The front face material 81 may only partially the light transmittance film 72. The front face material 81 and the back face material 82 are fused by thermal sealing along their edges.

FIG. 24 is a schematic cross-sectional view of a humidity-controlling material with a packaging member in accordance with a variation example of Embodiment 3.

In a humidity-controlling material 5M with a packaging member in accordance with the variation example of Embodiment 3 shown in FIG. 24, the packaging member 62 is a lidded box and includes a lid 131 and a box 132. The lid 131 is permeable to moisture. The box 132 is transparent to light. The box 132 is made of, for example, polyethylene terephthalate. The lidded box may be a blister pack. The lid 131 and the box 132 are fused by thermal sealing along their edges.

The present disclosure is not limited to the description of the embodiments and examples above. Any structure detailed in the embodiments and examples may be replaced by a practically identical structure, a structure that delivers practically the same effect and function, or a structure that achieves practically the same purpose.

What is claimed is:

1. A humidity-controlling material comprising:
a water-absorbing body containing a water-absorbing material; and
a humidity-controlling component configured to be present in the water-absorbing material and to absorb or release moisture, wherein
the humidity-controlling component comprises:
a first salt containing first anions and first cations and having a deliquescence point in a relative humidity range of from 30% RH to 80% RH both inclusive; and
a second salt containing second anions that differ from the first anions and second cations that differ from the first cations.

2. The humidity-controlling material according to claim 1, wherein the first salt forms hydrate crystals in a relative humidity range of from 30% RH to 80% RH both inclusive.

3. The humidity-controlling material according to claim 1, wherein the first salt is either a carboxylate or a carbonate.

4. The humidity-controlling material according to claim 1, wherein the first salt is sodium formate, sodium acetate, sodium propionate, or potassium carbonate.

5. The humidity-controlling material according to claim 1, wherein the second salt has a deliquescence point that differs from the deliquescence point of the first salt.

6. The humidity-controlling material according to claim 1, wherein the second salt has a deliquescence point in a relative humidity range of below 30% RH.

7. The humidity-controlling material according to claim 1, wherein the second salt is a potassium salt.

8. The humidity-controlling material according to claim 1, wherein the second salt is potassium lactate, potassium acetate, potassium carbonate, or potassium propionate.

9. The humidity-controlling material according to claim 1, wherein the water-absorbing body is in particulate, powder, or sheet form.

10. The humidity-controlling material according to claim 1, wherein the water-absorbing material contains at least one species selected from the group consisting of water-absorbing resins and clay minerals.

11. The humidity-controlling material according to claim 10, wherein the water-absorbing resins contain a sodium polyacrylate.

12. The humidity-controlling material according to claim 1, wherein the water-absorbing body includes a support that supports the water-absorbing material.

13. The humidity-controlling material according to claim 12, wherein the support is a porous body.

14. The humidity-controlling material according to claim 13, wherein the porous body is a foamed body, a nonwoven fabric, or a woven fabric.

15. The humidity-controlling material according to claim 1, further comprising an indicator configured to change color with a moisture content of the humidity-controlling component.

16. The humidity-controlling material according to claim 15, wherein the indicator contains an pH indicator.

17. The humidity-controlling material according to claim 1, wherein
the humidity-controlling component contains water, and
the water in the humidity-controlling component has a mass fraction within a ±10% range of a moisture absorption ratio that corresponds to a prescribed relative humidity on a moisture sorption isotherm of the humidity-controlling material containing the first salt and the second salt.
